(19) United States
(12) Patent Application Publication
(10) Pub. No.: US 2012/0228272 A1
(43) Pub. Date: Sep. 13, 2012

(54) WELDING APPARATUS FOR INDUCTION MOTOR AND METHOD OF WELDING INDUCTION MOTOR

(75) Inventors: Blair E. Carlson, Ann Arbor, MI (US); Richard M. Kleber, Clarkston, MI (US); Robert T. Szymanski, St. Clair Township, MI (US); John S. Agapiou, Rochester Hills, MI (US); David R. Sigler, Shelby Township, MI (US)

(73) Assignee: GM GLOBAL TECHNOLOGY OPERATIONS LLC, Detroit, MI (US)

(21) Appl. No.: 13/045,648

(22) Filed: Mar. 11, 2011

(51) Int. Cl. B23K 9/16; B23K 26/00; B23K 15/00; B23K 9/00

(52) U.S. Cl. 219/75; 219/121.45; 219/121.63; 219/121.13; 219/121.14; 219/121.46; 219/121.64

(57) ABSTRACT

A welding apparatus for an induction motor includes a fixture operable to support a rotor and rotate the rotor about an axis of rotation of the motor, and a welding head supported adjacent the fixture and operable to weld conductor bars located about the surface of the rotor to the first shorting ring when the fixture supports the rotor. A controller controls the fixture to selectively rotate the rotor. The controller moves the welding head, the fixture, or both, so that the welding head is in a welding position, and causes the welding head to weld the conductor bars to the first shorting ring while remaining in the welding position, with the rotor rotating to create a substantially circular weld path along the first shorting ring. In some embodiments, the conductor bars are welded to both shorting rings simultaneously. A method of welding an induction motor is also provided.

### TECHNICAL FIELD

The invention relates to a welding apparatus for welding conductor bars to shorting rings on an induction motor, and a method of welding the same.

### BACKGROUND

An alternating current (AC) induction motor is a particular type of electric motor that uses induced current flow to cause portions of the motor's rotor to become magnetized during operation of the motor. The induced current flows through conductor bars that are parallel to the axis of rotation of the rotor and surround the perimeter of the rotor core.

Known methods of manufacturing induction motor rotors are time consuming and relatively expensive. One common practice is to assemble pre-manufactured conductor bars and shorting rings onto the laminate stack and braze the assembly together. Another known method is to die cast the shorting rings and conductor bars together in a mold around the rotor stack. With certain materials, such as copper, die casting is difficult to carry out while maintaining the integrity of the cast components, as copper tends to react with the surfaces of the die.

### SUMMARY

A welding apparatus for an induction motor and a method of welding an induction motor using the welding apparatus are provided. The induction motor has an annular rotor defining an axis of rotation, and conductor bars spaced about an outer surface of the annular rotor. First and second shorting rings are connected at first and second ends of the annular rotor. The apparatus includes a fixture operable to support the rotor and rotate the rotor about the axis of rotation. A welding head is supported adjacent the fixture and is operable to weld the conductor bars to the first shorting ring when the fixture supports the rotor. Furthermore, the apparatus includes at least one controller operable to control the fixture to selectively rotate the rotor. The controller is operable to move the welding head, the fixture, or both, so that the welding head is in a welding position. The controller is operable to cause the welding head to weld the conductor bars to the first shorting ring while remaining in the welding position with the rotor rotating to create a substantially circular weld path along the first shorting ring.

In some embodiments, a second welding head is supported adjacent the fixture such that the second welding head is axially spaced from the first welding head and is operable to weld the conductor bars to the second shorting ring when the fixture supports the rotor. The controller is operable to move the second welding head between a respective initial position and a respective welding position. The controller causes the second welding head to weld the conductor bars to the second shorting ring while remaining in the respective welding position with the rotor rotating to create a second substantially circular weld path along the second shorting ring simultaneously with the first substantially circular weld path.

A method of welding an induction motor using the welding apparatus is also provided. The method includes supporting the rotor such that the rotor is rotatable about the axis of rotation, positioning a welding head in a predetermined welding position adjacent the portion of the shorting ring into which the conductor bars extend, and then simultaneously rotating the rotor and welding the conductor bars to the shorting ring with the welding head remaining substantially in the predetermined position so that the welding head welds along a substantially circular weld path.

The apparatus and method reduce the cycle time of producing a rotor for an induction motor. Because the welding head is relatively fixed while the rotor turns during welding, an accurate and precise weld path is established without the time-intensive positioning and repositioning of the welding head at each end of each conductor bar. The apparatus and method are conducive to using an aluminum alloy or a copper alloy for the conductor bars and the shorting rings, but are not limited to such materials. The conductor bars may be one material, such as copper, and the shorting rings a different material, such as aluminum. The copper alloy has a higher power density and better heat transfer capability than rotors with typical aluminum alloy components. In some embodiments, the opposite ends of the rotor bars may be welded to the shorting rings simultaneously, significantly reducing cycle time. This makes it feasible to use friction stir welding (FSW), which is a relatively slow weld, as the weld cycle time is cut in half in embodiments of the apparatus in which both ends of the conductor bars are welded to both shorting rings at the same time. With FSW, a solid state weld is achieved, and the characteristics of the materials welded together remain largely unchanged because the welding process does not create temperatures above the melting temperature of the welded material. Thus, the conductivity of the welded components is not compromised.

Furthermore, the apparatus and method allow the welding to be by a fusion welding process. Fusion welding is a welding process that melts the base metals at the joint, and includes gas metal arc welding (GMAW), gas tungsten arc welding (GTAW), plasma arc welding, electron beam welding, laser welding, or a combination of laser welding and GMAW, GTAW or plasma welding. Because the welding head remains substantially stationary during the weld, and because the rotating rotor has a consistent cylindrical shape, a shield may be customized to fit around the welding head close to the rotating rotor to create a substantially enclosed chamber. The chamber and shield allow an inert environment in which the fusion welding process can occur without impurities that could compromise the integrity of the weld. In the case of laser beam welding (LBW) and electron beam welding (EBW), the shield also covers the beam to prevent inadvertent exposure and protect an operator's eyes.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration of a first embodiment of a welding apparatus for welding a rotor of an induction motor;

FIG. 2 is a flow diagram of a method of welding a rotor with the welding apparatus of FIG. 1;

FIG. 3 is a schematic perspective illustration of a second embodiment of a welding apparatus for welding a rotor of an induction motor;

FIG. 4 is a flow diagram of a method of welding a rotor with the welding apparatus of FIG. 3;

FIG. 5 is a schematic perspective illustration of a third embodiment of a welding apparatus for welding a rotor of an induction motor;

FIG. 6 is a flow diagram of a method of welding a rotor with the welding apparatus of FIG. 5;

FIG. 7 is a schematic perspective illustration of a rotor for an induction motor welded by the welding apparatus of FIG. 1;

FIG. 8 is a schematic perspective illustration of a rotor for an induction motor welded by the welding apparatus of FIG. 3;

FIG. 9 is a schematic perspective illustration of a rotor for an induction motor welded by the welding apparatus of FIG. 5;

FIG. 10 is a schematic perspective illustration of a fourth embodiment of a welding apparatus for welding a rotor of an induction motor; and

FIG. 11 is a schematic perspective illustration of a fifth embodiment of a welding apparatus for welding a rotor of an induction motor.

### DETAILED DESCRIPTION

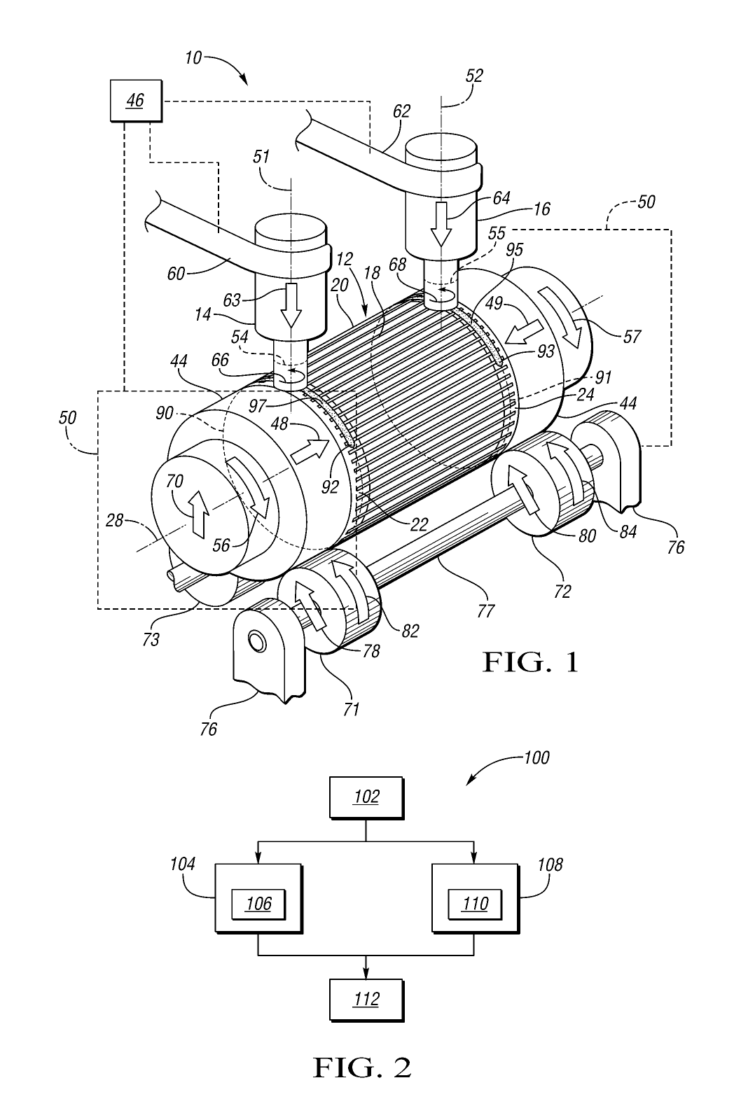

Referring to the drawings, wherein like reference numbers refer to like components throughout the several views, FIG. 1 shows a first embodiment of a welding apparatus 10 used for welding an alternating current (AC) induction motor 12. Specifically, the welding apparatus 10 uses first and second friction stir welding (FSW) heads 14, 16 to weld conductor bars 18 of an annular rotor 20 of the induction motor 12 to a first shorting ring 22 and a second shorting ring 24, respectively. The shorting rings 22, 24 are preferably a copper alloy or an aluminum alloy. As further described below, the welding heads 14, 16 simultaneously weld the conductor bars 18 to the shorting rings 22, 24, with the welding heads 14, 16 remaining relatively fixed and the rotor 20 rotating to weld along dual circular weld paths.

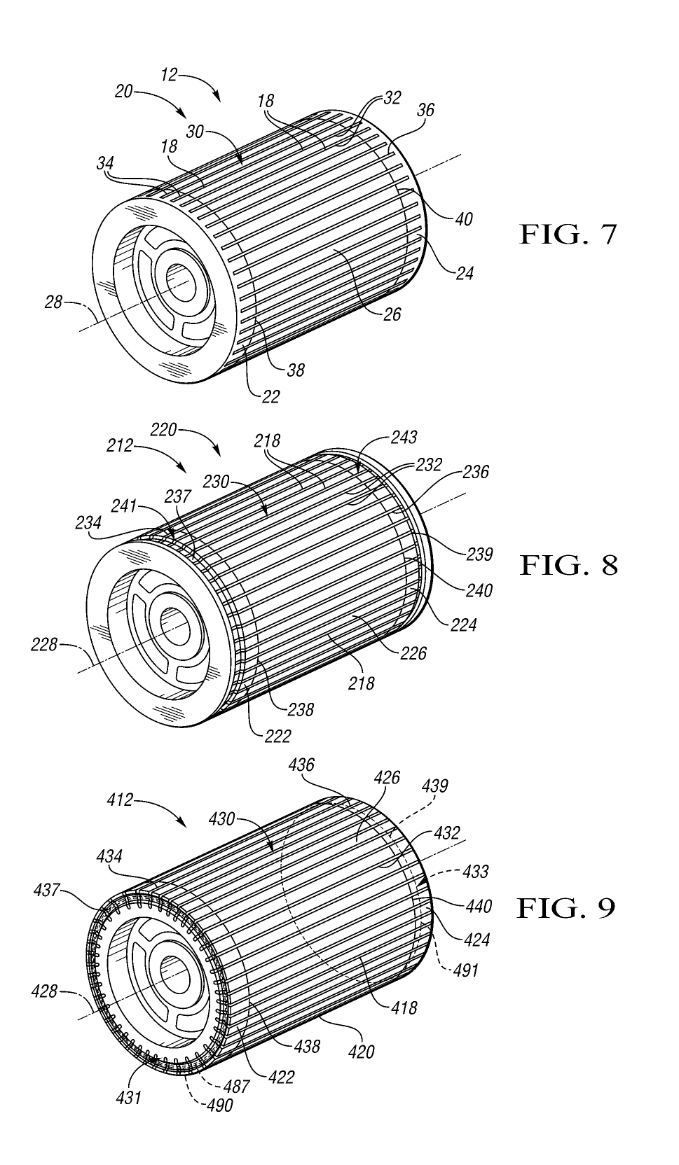

Referring to FIG. 7, the rotor 20 is shown prior to welding of the conductor bars 18 to the shorting rings 22, 24. When completed, the induction motor 12 will also include a stator that is not shown. The rotor 20 includes a laminate stack 26 of identical thin annular plates of highly magnetic steel stacked axially to define a center axis of the rotor 20, which is also the axis of rotation 28 of the rotor 20. Those of ordinary skill in the art readily understand how to manufacture and assemble the laminate stack 26. The conductor bars 18 are imbedded in the perimeter of the laminate stack 26 so that they are spaced about an outer surface 30 of the rotor 20. The laminate stack 26 forms a series of identical grooves 32 that surround its perimeter in a periodic spacing. The conductor bars 18 are substantially encapsulated by the stack 26 in the grooves 32 in such a manner that the outer faces of the conductor bars 18 are exposed on the outer surface 30 of the rotor 20.

The shorting rings 22, 24 are manufactured with grooves 34, 36, respectively. The grooves 34, 36 are spaced about the outer surface of the shorting rings 22, 24 with a spacing identical to the spacing of the grooves 32 of the rotor 20, so that the grooves 34, 32, 36 align when the shorting rings 22, 24 are attached to the first end 38 and the second end 40 of the rotor 20, respectively. The conductor bars 18 extend beyond the laminate stack 26, and fit into the grooves 34, 36 when the shorting rings 22, 24 are attached to the rotor 20. In the embodiment of FIG. 7, the grooves 34, 36 extend only partway through the axial width of each of the shorting rings 22, 24. In other embodiments, the grooves 34, 36 and the conductor bars 18 could be manufactured so that the conductor bars 18 extend through the entire width of the shorting rings 22, 24.

Referring again to FIG. 1, in order to complete the connection between the conductor bars 18 and the shorting rings 22, 24 to enhance the conductivity and performance of the rotor 20, the shorting rings 22, 24 are welded to the conductor bars 18. The welding apparatus 10 is designed to allow the welding process to occur in an efficient and precise manner. The welding apparatus 10 includes a fixture 44 that fits on both ends of the shorting rings 22, 24 at the same time to clamp and support the assembled shorting rings 22, 24 and rotor 20. The fixture 44 may also be referred to as a clamping lathe. The fixture 44 is operable in response to control signals from a controller 46. Movement of the fixture 44, as described below, may be accomplished by electric actuators, pneumatic pressure, hydraulic pressure, gearing arrangements, or otherwise, provided through actuating portions 50 of the fixture 44, shown only in phantom. Those of ordinary skill in the art will readily understand a variety of ways to actuate the fixture 44, similarly to actuation of a robotic lathe. The fixture 44 moves inward toward the assembled rotor 20 and shorting rings 22, 24 to apply a clamping force indicated by arrows 48, 49. To remove the clamping force 48, 49 and release the rotor 20 and shorting rings 22, 24 from the welding apparatus 10, the fixture 44 is moved in the opposite directions of arrows 48, 49, i.e., away from the assembled rotor 20 and shorting rings 22, 24.

The fixture 44 is also controllable by the controller 46 to rotate in the direction of arrows 56, 57. When the fixture 44 is clamped to the rotor 20 and shorting rings 22, 24 as shown in FIG. 1, the rotor 20 and shorting rings 22, 24 rotate with the fixture 44.

The welding heads 14, 16 are supported by robotic arms 60, 62. The robotic arms 60, 62 are movable in response to control signals sent by the controller 46 to move the welding heads 14, 16 along center axes 51, 52, of the welding heads 14, 16. The axes 51, 52 may be perpendicular to and may intersect the axis of rotation 28 of the rotor 20. In FIG. 1, the welding heads 14, 16 are shown in predetermined welding positions. In the predetermined welding positions, the welding heads 14, 16 are adjacent to (i.e., just above) a portion of the shorting rings 22, 24 into which the conductor bars 18 extend. After the fixture 44 clamps the rotor 20 with shorting rings 22, 24 in the position shown in FIG. 1, the arms 60, 62 move the welding heads 14, 16 in the direction of arrows 63, 64 from initial positions indicated as 54, 55, at which the distal end of the welding heads 14, 16 are at a distance above the shorting rings 22, 24, to the welding positions shown in which the distal ends are in contact with the shorting rings 22, 24 and conductor bars 18.

The welding heads 14, 16 are friction stir welding (FSW) heads. Once in the welding positions shown, the controller 46 is operable to rotate the welding heads 14, 16 in the direction of arrows 66, 68 to begin welding the conductor bars 18 to the shorting rings 22, 24. The friction stir welding heads 14, 16 are plunged slightly into the shorting rings 22, 24 and conductor bars 18 while the heads 14, 16 rotate to stir the material along the weld path. Rotating weld heads that plunge into the material to be welded while rotating to stir the material are known in the art of FSW. This action of the heads 14, 16 may create a substantial downward force on the shorting rings 22, 24. The fixture 44 provides a reaction force 70 to balance the forces of the welding heads 14, 16. Depending on the force reaction capability of the fixture 44, it may be desirable to support the assembled rotor 20 and shorting rings 22, 24 near the plane of each of the FSW heads 14, 16. Rollers 71 and 72 are rotatably supported by another fixture 76 on a shaft 77 in such a manner that, in the embodiment shown, they provide reaction forces 78, 80 at the fixture 44 to counteract the high welding forces. The rollers 71, 72 have rotational freedom to rotate, as indicated by arrows 82, 84, in response to rotation of the assembled rotor 20 and shorting rings 22, 24 by the fixture 44. Another set of similar rollers are supported on a similar fixture and shaft on the opposite side of the rotor 20. Only one of these rollers 73 is shown in FIG. 1 for purposes of clarity in the drawing. In other embodiments, the rollers 71, 72, 73 could be axially-aligned with the welding heads 14, 16 and could be provided with a circumferential channel interfacing with the shorting rings 22, 24 at the weld paths in order to accommodate any flash or raised level of the weld material. A cutting operation could be positioned to immediately follow the weld deposit to remove any flash.

As both weld heads 14, 16 are plunging and rotating while remaining substantially in the welding positions shown, the fixture 44 simultaneously turns the assembled rotor 20 and shorting rings 22, 24 so that the weld heads 14, 16 weld along dual circular weld paths 90, 91, indicated in phantom. A portion of the completed welds are shown as 95, 97, as the fixture 44 has turned the assembled rotor 20 and shorting rings 22, 24 from a position in which points 92, 93 were directly under the welding heads 14, 16 to the position shown in FIG. 1. The fixture 44 will continue rotating the assembled rotor 20 and shorting rings 22, 24 for a complete rotation, until points 92, 93 are again directly under the welding heads 14, 16, thereby simultaneously welding the shorting rings 22, 24 and conductor bars 18 to one another along the dual circular weld paths 90, 91. At the end of 360 degrees of rotation, or slightly more as required, the welding is completed, with the conductor bars 18 being welded to both shorting rings 22, 24 in a single rotating cycle.

If the shorting rings 22, 24 are a copper alloy, friction stir welding is especially advantageous as the copper alloy of the shorting rings 22, 24 remains at a relatively low temperature compared to temperatures reached in other types of welding. At high temperatures, the copper alloy can absorb oxides, with a resulting decrease in its conductivity. At the lower temperatures, oxides are not absorbed by the copper alloy. Friction stir welding is also advantageous to weld copper to aluminum.

A method 100 of welding the induction motor 12 of FIGS. 1 and 7 is shown in the flow diagram of FIG. 2. The method 100 is carried out by the controller 46 pursuant to an algorithm stored in a processor within the controller. The method 100 includes block 102, supporting the rotor 20 with attached shorting rings 22, 24 such that the rotor 20 is rotatable about the axis of rotation 28. In block 104, the welding head 14 is positioned in the predetermined welding position shown in FIG. 1 adjacent the portion of the shorting ring 22 into which the conductor bars 18 extend. The positioning of block 104 includes block 106, moving the welding head 14 substantially along the center axis 51 from an initial position, indicated at position 54, to the predetermined welding position shown. The moving in block 106 is by the robotic arm 60. In block 108, the second welding head 16 is positioned in a second predetermined welding position adjacent the portion of the shorting ring 24 into which the conductor bars 18 extend, as shown in FIG. 1. Block 108 includes block 110, moving the welding head 16 substantially along the center axis 52 from an initial position, indicated as position 55, to the predetermined welding position shown. Positioning of the welding heads 14, 16 in blocks 104 and 108 may be carried out simultaneously. In some embodiments, the arms 60, 62 may be interconnected to move together under the control of the controller 46. In still other embodiments, the welding heads 14, 16 could be attached to a pivoting fixture such that they pivot downward to the welding positions of FIG. 1. Additionally, the fixture 44 could be configured to move the rotor 20 with attached shorting rings 22, 24 toward the welding heads 14, 16 with the welding heads 14, 16 remaining fixed in the welding position shown.

Once the welding heads are positioned, in block 112 the welding heads 14, 16 are controlled to weld the conductor bars 18 to the shorting rings 22, 24 simultaneously as the fixture 44 is controlled to rotate the rotor 20 with attached shorting rings 22, 24 about the center axis 28, simultaneously creating welds along the dual circular weld paths 90, 91.

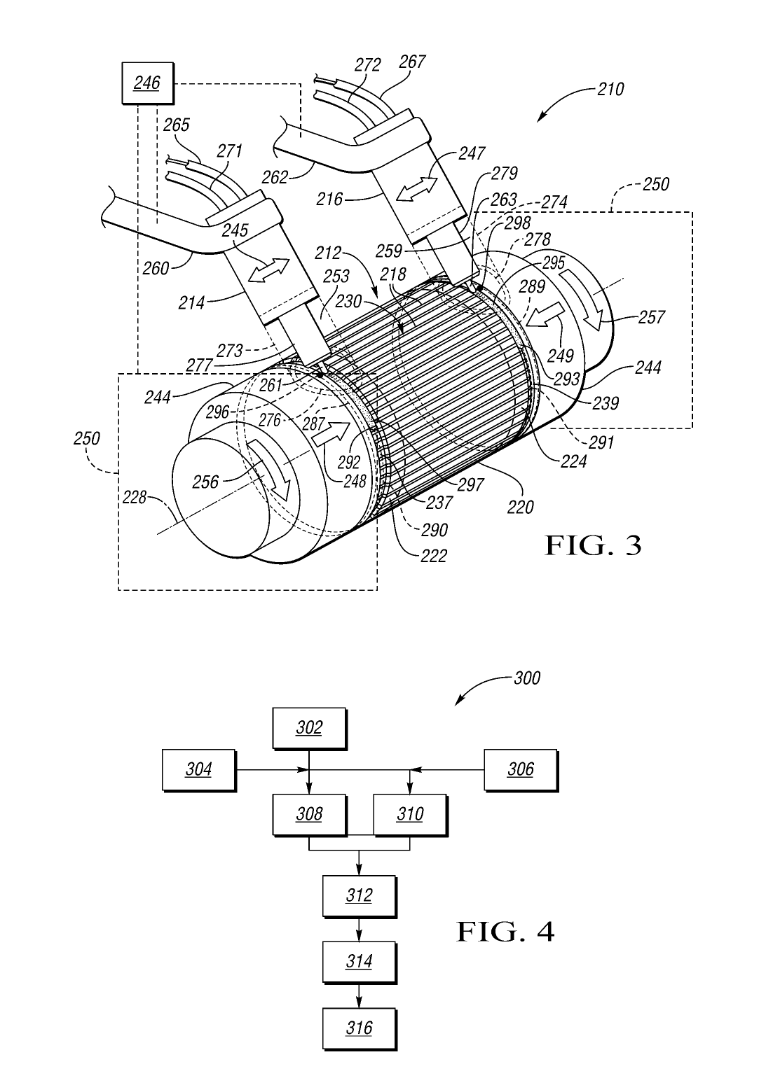

FIG. 3 shows a second embodiment of a welding apparatus 210 used for welding an AC induction motor 212. Specifically, the welding apparatus 210 uses first and second fusion welding heads, such as gas metal arc welding (GMAW) heads, gas tungsten arc welding (GTAW) heads, plasma arc welding heads, electron beam welding heads, laser beam welding heads, or a combination of laser beam welding and GMAW, GTAW or plasma arc welding heads. In this embodiment, the welding heads 214, 216 are GMAW welding heads that weld conductor bars 218 of an annular rotor 220 of the induction motor 212 to a first shorting ring 222 and a second shorting ring 224, respectively, but could also represent GTAW welding heads or plasma arc welding heads. The shorting rings 222, 224 are preferably a copper alloy or an aluminum alloy. As further described below, the welding heads 214, 216 simultaneously weld the conductor bars 218 to the shorting rings 222, 224, with the welding heads 214, 216 remaining relatively fixed and the rotor 220 rotating to weld along dual circular weld paths.

Referring to FIG. 8, the rotor 220 is shown prior to welding of the conductor bars 218 to the shorting rings 222, 224. When completed, the induction motor 212 will also include a stator that is not shown. The rotor 220 includes a laminate stack 226 of identical thin annular plates of highly magnetic steel stacked axially to define a center axis of the rotor 220, which is also the axis of rotation 228 of the rotor 220. Those of ordinary skill in the art readily understand how to manufacture and assemble the laminate stack 226. The conductor bars 218 are imbedded in the perimeter of the laminate stack 226 so that they are spaced about an outer surface 230 of the rotor 220. The laminate stack 226 forms a series of identical grooves 232 that surround its perimeter in a periodic spacing. The conductor bars 218 are substantially encapsulated by the stack 226 in the grooves 232 in such a manner that the outer faces of the conductor bars 218 are exposed on the outer surface 230 of the rotor 220.

The shorting rings 222, 224 are manufactured with grooves 234, 236, respectively. The grooves 234, 236 are spaced about the outer surfaces 241, 243 of the shorting rings 222, 224 with a spacing identical to the spacing of the grooves 232 of the rotor 220, so that the grooves 234, 232, 236 align when the shorting rings 222, 224 are attached to the first end 238 and the second end 240 of the rotor 220, respectively. The conductor bars 218 extend beyond the laminate stack 226, and fit into the grooves 234, 236 when the shorting rings 222, 224 are attached to the rotor 220. In the embodiment of FIG. 8, the grooves 234, 236 extend through the axial width of each of the shorting rings 222, 224. The shorting rings 222, 224 are also formed with circumferential grooves 237, 239, respectively, on the outer cylindrical surfaces 241, 243, respectively, at the axial ends of the shorting rings 222, 224. The conductor bars 218 taper at their ends where the grooves 232 intersect with the grooves 234, 236 and are exposed in the grooves 237, 239.

Referring again to FIG. 3, in order to complete the connection between the conductor bars 218 and the shorting rings 222, 224 to enhance the conductivity and performance of the rotor 220, the shorting rings 222, 224 are welded to the conductor bars 218. The welding apparatus 210 is designed to allow the welding process to occur in an efficient and precise manner. The welding apparatus 210 includes a fixture 244 that fits on both ends of the shorting rings 222, 224 at the same time to clamp and support the assembled shorting rings 222, 224 and rotor 220. The fixture 244 may also be referred to as a clamping lathe. The fixture 244 is operable in response to control signals from a controller 246. Movement of the fixture 244, as described below, may be accomplished by electric actuators, pneumatic pressure, hydraulic pressure, gearing arrangements, or otherwise, provided through actuating portions 250 of the fixture 244, shown only in phantom. Those of ordinary skill in the art will readily understand a variety of ways to actuate the fixture 244, similarly to actuation of a robotic lathe. The fixture 244 moves inward toward the assembled rotor 220 and shorting rings 222, 224 to apply a clamping force indicated by arrows 248, 249. To remove the clamping force 248, 249 and release the rotor 220 and shorting rings 222, 224 from the welding apparatus 210, the fixture 244 is moved in the opposite directions of arrows 248, 249, i.e., away from the assembled rotor 220 and shorting rings 222, 224.

The fixture 244 is also controllable by the controller 246 to rotate in the direction of arrows 256, 257. When the fixture 244 is clamped to the rotor 220 and shorting rings 222, 224 as shown in FIG. 3, the rotor 220 and shorting rings 222, 224 rotate with the fixture 244.

The welding heads 214, 216 are supported by robotic arms 260, 262. The robotic arms are movable in response to control signals sent by the controller 246 to move the welding heads 214, 216 in a radial direction, perpendicular to the axis of rotation 228 in order to bring the welding heads 214, 216 close to the surface of the shorting rings 222, 224, and then away from the shorting rings 222, 224 after completion of the welds to allow room for removal of the rotor 220 and loading of the next motor 212. Alternately, the rotor 220 with attached shorting rings 222, 224 could be moved toward the welding heads 214, 216. The welding heads 214, 216 also can be moved axially, parallel to the axis of rotation 228, to move between adjacent weld paths, as discussed below.

In FIG. 3, the welding heads 214, 216 are shown in first predetermined welding positions. In the predetermined welding positions, the welding heads 214, 216 are adjacent to (i.e., just above) the grooves 237, 239 of the shorting rings 222, 224 into which the conductor bars 218 extend. After the fixture 244 clamps the rotor 220 with shorting rings 222, 224, the GMAW welding heads 214, 216 with respective welding torches 277, 279 are fixed in a biased radial position relative to the rotor 220 that is appropriate for the delivery feed of wire electrodes 261, 263. The welding heads 214, 216 have the ability to translate axially via the robotic arms 260, 262 along the width of the respective groove 237, 239 as the weld pattern is implemented. The wire electrodes 261, 263 are automatically fed into the welding torches 277, 279 of the respective welding heads 214, 216 through tubes 265, 267 from supply reels at a controlled rate.

A shielding gas, such as argon or argon and helium, either of which can be mixed with a low percentage of nitrogen, hydrogen, or carbon dioxide, is flooded into the arc area of the weld through gas supply tubes 271, 272. The shielding gas limits or eliminates the effects of oxygen or other naturally occurring gasses in the atmosphere on the weld quality. The shielding gas is dispersed into chambers 253, 259 defined by shields 273, 274, on the respective welding heads 214, 216, that allow for the welding heads 214, 216 to be oriented in a large variety of positions in relation to the rotor 220. The shields 273, 274 are shown in phantom to allow a view of the components, such as the electrodes 261, 263. Optional seals 276, 278 may be attached to the respective shields 273, 274 to contact or closely follow the outer surface 230 of the rotor 220 and shorting rings 222, 224 as the fixture 244 turns, further enhancing the isolation of the chambers 253, 259 from the atmosphere. In one embodiment, the seals 276, 278 may be high temperature fiberglass rope seals with a metallic core, seals with a reinforced composite construction, or other similar seals.

Other than slight axial movement described below, the orientation of the welding heads 214, 216 relative to the rotor 220 does not change during the course of the weld. The consistent cylindrical shape of the rotor 220 and the limited axial translation of the welding heads 214, 216 offer an opportunity to enclose the weld torch 277, 279 of the welding heads 214, 216 in a very effective shield configuration, with the shields 273, 274 having a shape that complements the cylindrical shape of the outer surface 230 of the rotor 220, and the cylindrical shape of the outer surface of the shorting rings 222, 224 and the fixture 244, so that the chambers 253, 259 are substantially isolated from the surrounding atmosphere, thereby significantly reducing the exposure of the weld area beneath the weld torches 277, 279 to atmospheric contamination. Specifically, the open ends of the respective shields 273, 274 including any optional seals 276, 278, when viewed from the side, have a shape that is a segment of a circle substantially the same size as the rotor 220, so that the shields 273, 274 including any optional seals 276, 278 match the cylindrical outer surface 230 with only a slight gap therebetween sized to allow shielding gas flow to escape.

To start the manufacturing cycle, referring to FIG. 3, the rotor 220 with attached shorting rings 222, 224 is inserted into the clamping fixture 244 to ensure the precise radial and axial position of the rotor 220 and shorting rings 222, 224, and to supply an electrical grounding path for welding. In this position, the outer surface 230 of the rotor 220 is slightly below the lower portion of the shields 273, 274 with optional seals 276, 278 and the shorting bar grooves 237, 239 are aligned with the continuous wire electrodes 261, 263 as they protrude from the GMAW welding torches 277, 279. After the rotor 220 and shorting rings 222, 224 are in this position, the shield gas is introduced through the supply tubes 271, 272 from a reservoir (not shown), to evacuate the ambient atmospheric gas from the chambers 253, 259 and provide the needed inert environment. Finally, the welds are initiated as the rotation of the rotor 220 and shorting rings 222, 224 by the fixture 244 and the feed speed of the continuous wire electrodes 261, 263 are synchronized to fill the respective grooves 237, 239 with molten metal that quickly solidifies in the shielded environment. While both welding heads 214, 216 are controlled to weld the rotor 220 and shorting rings 222, 224 substantially in the predetermined welding positions shown, the fixture 244 simultaneously turns the assembled rotor 220 and shorting rings 222, 224 so that the welding heads 214, 216 weld along dual circular weld paths 290, 291, indicated in phantom. A portion of the completed welds are shown as 295, 297, as the fixture 244 has turned the assembled rotor 220 and shorting rings 222, 224 from a position in which points 292, 293 were directly under the welding heads 214, 216 to the position shown in FIG. 3.

The fixture 244 will continue rotating the assembled rotor 220 and shorting rings 222, 224 for a complete rotation, until points 292, 293 are again directly under the welding heads 214, 216, thereby simultaneously welding the shorting rings 222, 224 and conductor bars 218 to one another along the dual circular weld paths 290, 291. At the end of 360 degrees of rotation, if the grooves 237, 239 are wider than the weld along weld paths 290, 291, the controller 246 will cause the welding heads 214, 216 to move axially as indicated by arrows 245, 247 so that the weld tips 261, 263 are at additional welding positions 296, 298. In this embodiment, both weld tips 261, 263 would move further away from the rotor 220 in the grooves 237, 239 to begin second weld paths in this embodiment. The fixture 244 would continue rotating the rotor 220 with shorting rings 222, 224 attached thereto to create second substantially circular welds along second substantially circular weld paths 287, 289 axially adjacent to the respective weld paths 290, 291 so that there are two side-by-side welds in each of the grooves 237, 239. Alternately, the robotic arms 260, 262 may be a fixed distance apart from one another so that the robotic arms 260, 262 move the welding heads 214, 216 in unison in the same direction along the axis of rotation 228 to positions aligned with respective second welding paths.

As many additional iterations of slight axial movement of the welding heads 214, 216 and rotation of the fixture 244 can be carried out until the grooves 237, 239 are adequately filled with weld material. Welding would then be complete, with both shorting rings 222, 224 being welded to the conductor bars 218 simultaneously. At the conclusion of the weld pattern, the rotor 220 with shorting rings 222, 224 is removed from the fixture 244. If the welding heads 214, 216 were moved axially during welding, then they are again moved axially to return to their original welding positions shown in FIG. 3. Another rotor with shorting rings can then be placed in the fixture 244 for the start of the next welding cycle.

A method 300 of welding the induction motor 212 of FIGS. 3 and 8 is shown in the flow diagram of FIG. 4. The method 300 is carried out by the controller 246 pursuant to an algorithm stored in a processor in the controller 246. The method 300 includes block 302, supporting the rotor 220 with attached shorting rings 222, 224 such that the rotor 220 is rotatable about the axis of rotation 228. The method 300 further includes block 304, attaching a shield 273 to the welding head 214, with the shield 273 having a shape at a distal end that is configured to be substantially complementary to the cylindrical outer surface 230 of the rotor 220. Similarly, in block 306, a shield 274 has a shape at a distal end that is configured to be substantially complementary to the cylindrical outer surface 230 of the rotor 220. The shields 273, 274 may be attached during the initial assembly of the welding apparatus 210, prior to the welding of the rotor 220.

In block 308, the welding head 214 is positioned in the predetermined welding position shown in FIG. 3 adjacent the groove 237 of the shorting ring 222 into which the conductor bars 218 extend. In block 310, the welding head 216 is positioned in the predetermined welding position shown in FIG. 3 adjacent the groove 239 of the shorting ring 224 into which the conductor bars 218 extend. In one embodiment, the robotic arms 260, 262 may be attached to a common pivot to move the welding heads 214, 216 commonly down towards the positions shown in FIG. 3 under the control of controller 246. Alternately, the rotor 220 with attached shorting rings 222, 224 could be moved toward the welding heads 214, 216.

With the welding heads 214, 216 in the predetermined welding positions and the rotor 220 with attached shorting rings 222, 224 supported by the fixture 244, in block 312, the welding heads 214, 216 are then controlled to simultaneously weld the conductor bars 218 to the shorting rings 222, 224 as the fixture 244 turns the rotor 220, creating dual circular weld paths 290, 291.

Depending on the width of the grooves 237, 239, more than one substantially circular weld within the each groove 237, 239 may be desirable. In some embodiments, additional welding may be desirable, and the method 300 may include block 314, moving the welding heads 214, 216 axially with respect to the rotor 220, within the grooves 237, 239. The moving in block 314 is by the robotic arms 260, 262, and is in the axial direction indicated by double-sided arrows 245 and 247. In the embodiment shown, welding heads 214 and 216 move away from the rotor 220 within the respective grooves 237, 239. In other embodiments, the welding heads 214, 216 may move in the same axial direction. In block 316, the welding heads 214, 216 are controlled to weld while the fixture 244 rotates the rotor 220 with attached shorting rings 222, 224, thus welding along substantially circular weld paths 287, 289, creating side-by-side welds in each of the grooves 237, 239. After the welding is complete, the fixture 244 releases the rotor 220 and shorting rings 222, 224.

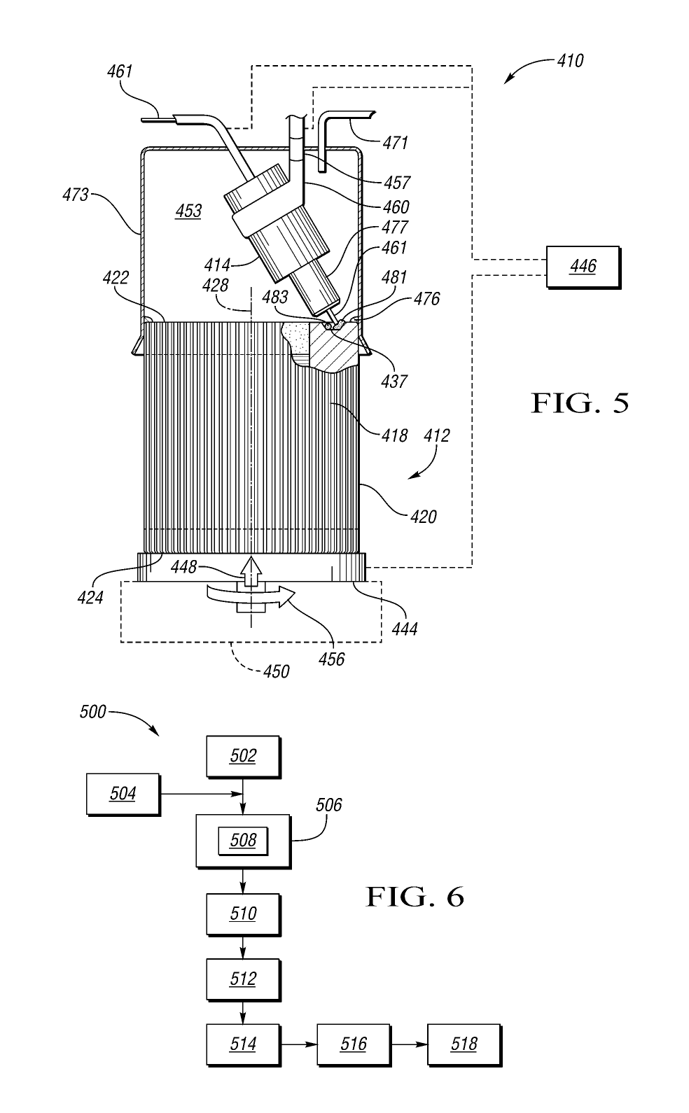

FIG. 5 shows a third embodiment of a welding apparatus 410 used for welding an AC induction motor 412. Specifically, the welding apparatus 410 uses a metal fusion welding head, such as an gas metal arc welding (GMAW) head, a gas tungsten arc welding (GTAW) head, a plasma arc welding head, an electron beam welding head, laser beam welding head, or a combination of laser beam welding and a GMAW, GTAW or plasma arc welding head. In this embodiment, the welding head 414 is a GMAW welding head 414, also referred to as a welding torch, to weld conductor bars 418 of an annular rotor 420 of the induction motor 412 to a first shorting ring 422 and a second shorting ring 424, respectively. The shorting rings 422, 424 are preferably a copper alloy or an aluminum alloy. As further described below, the welding head 414 welds the conductor bars 418 to the shorting ring 422, with the welding head 414 remaining relatively fixed. The fixture 444 rotates the rotor 420 with attached shorting rings 422, 424 so that the welding head 414 welds along a substantially circular weld path 490 shown in FIG. 9. The rotor 420 with attached shorting rings 422, 424 is then repositioned in the fixture 444 so that the second shorting ring 424 can be welded to the conductor bars 418 in the same manner.

Referring to FIG. 9, the rotor 420 is shown prior to welding of the conductor bars 418 to the shorting rings 422, 424. When completed, the induction motor 412 will also include a stator that is not shown. The rotor 420 includes a laminate stack 426 of identical thin annular plates of highly magnetic steel stacked axially to define a center axis of the rotor, which is also the axis of rotation 428 of the rotor. Those of ordinary skill in the art readily understand how to manufacture and assemble the laminate stack 426. The conductor bars 418 are imbedded in the perimeter of the laminate stack 426 so that they are spaced about an outer surface 430 of the rotor 420. The laminate stack 426 forms a series of identical grooves 432 that surround its perimeter in a periodic spacing. The conductor bars 418 are substantially encapsulated by the stack 426 in the grooves 432 in such a manner that the outer faces of the conductor bars 418 are exposed on the outer surface 430 of the rotor 420. A substantially circular groove 437 is formed in the end face 431 of the shorting ring 422. A substantially similar circular groove 439 is in the end face 433 of the shorting ring 424, and is obscured from view in FIG. 9. The annular grooves 437, 439 are machined or otherwise provided in the end faces 431, 433 of the shorting rings 422, 424 to allow for weld fill in the joining of the components.

The shorting rings 422, 424 also have grooves 434, 436 that are spaced about the outer surface of the shorting rings 422, 424 with a spacing identical to the spacing of the grooves 432 of the rotor 420, so that the grooves 434, 436 of the shorting rings 422, 424 align with the grooves 432 of the rotor 420 when the shorting rings 422, 424 are attached to the first end 438 and the second end 440 of the rotor 420, respectively. The conductor bars 418 extend beyond the laminate stack 426, and fit into the grooves 434, 436 when the shorting rings 422, 424 are attached to the rotor 420. The conductor bars 418 emerge nearly flush with the exposed end faces 431, 433 of the shorting rings 422, 424. In the embodiment of FIG. 9, the grooves 434, 436 extend through the axial width of each of the shorting rings 422, 424. The shorting rings 422, 424 are also formed with the circumferential grooves 437, 439, respectively, on the outer end faces 431, 433, respectively, at the axial ends of the shorting rings 422, 424. The conductor bars 418 are exposed in the grooves 437, 439 at their ends where the grooves 434, 436 intersect with the grooves 437, 439, respectively.

The grooves 437, 439 are not necessary in all embodiments. The requirement depends on the density of the grooves 432 on the perimeter, the diameter of rotor 420, and the clearance between the grooves 432 and the conductor bars 418. For example, the grooves 437, 439 will expose the conductor bars 418. The grooves 437, 439 are beneficial for high density conductor bars 418 and/or a small diameter rotor 420 in which case the distance between conductor bars 418 is small. In cases with a large diameter rotor 420 and/or low density conductor bars 418, the grooves 437, 439 are not necessary. Furthermore, the shorting rings 422, 424 are each made as a single piece or assembly of multiple annular plates of various thicknesses depending on the welding application and the manufacturing cost. If the shorting rings 422, 424 are made by stacking copper laminations together, the grooves 437, 439 are not present. In this case, the shorting rings 422, 424 are made as laminate stacks of thin annular plates of copper or aluminum material stacked axially. The copper or aluminum annular plates are as thin as necessary to be produced by the simplest process such as blanking. Therefore, the annular plates made for the shorting rings are usually thicker than the annular steel plates used for the rotor 420.

Referring again to FIG. 5, in order to complete the connection between the conductor bars 418 and the shorting rings 422, 424 to enhance the conductivity and performance of the rotor 420, the shorting rings 422, 424 are welded to the conductor bars 418. The welding apparatus 410 is designed to allow the welding process to occur in an efficient and precise manner. The welding apparatus 410 includes a fixture 444 that fits on either end of the shorting rings 422, 424 to clamp and support the assembled shorting rings 422, 424 and rotor 420. Unlike the fixtures 10 and 210 described above, the fixture 410 fits on only one shorting ring 422 or 424 at a a time. The fixture 444 may also be referred to as a clamping lathe. The fixture 444 is operable in response to control signals from a controller 446.

FIG. 5 shows a side view of the components involved in the fixturing and welding of the rotor assembly with a cutaway section in the area of the weld. The rotor 420 with attached shorting rings 422, 424 is securely placed on the fixture 444, which is capable of lifting the rotor 420 with attached shorting rings 422, 424 toward a welding head 414, as indicated by arrow 448, and causing rotation of the rotor 420 with attached shorting rings 422, 424 about axis of rotation 428 in a controllable manner, as indicated by arrow 456. Movement of the fixture 444, as described below, may be accomplished by electric actuators, pneumatic pressure, hydraulic pressure, gearing arrangements, or otherwise, provided through actuating portions 450 of the fixture 444, shown only in phantom. Those of ordinary skill in the art will readily understand a variety of ways to actuate the fixture 444, similarly to actuation of a robotic lathe. The fixture 444 may be moved in the opposite direction of arrow 448, i.e., away from the welding head 414 when the substantially circular weld in the groove 437 is completed.

The welding head 414 is supported by a robotic arm 460. The robotic arm 460 is movable in response to control signals sent by the controller 446 to move the welding head 414 radially with respect to the axis of rotation 428. A rubber boot 457 surrounds the robotic arm 460 where the robotic arm 460 passes through a shield 473 that is discussed further below. In FIG. 5, the welding head 414 is shown in a first predetermined welding position. In the first predetermined welding position, the welding head 414 is adjacent to (i.e., just above) the groove 437 of the shorting ring 422 into which the conductor bars 418 extend. The welding head 414 with welding torch 477 is fixed in a biased radial position relative to the rotor 420. The GMAW welding process uses a continuous wire electrode 461 that is automatically fed into the welding torch 477 from a supply reel (not shown) at a controlled rate.

A shielding gas, such as argon or argon and helium, either of which can be mixed with a low percentage of nitrogen, hydrogen, or carbon dioxide is flooded into the arc area of the weld to limit or eliminate the effects of oxygen or other naturally occurring gasses in the atmosphere on the weld quality. In the disclosed invention, the shielding gas is dispersed by gas supply line 471 and contained in the cylindrical containment shield 473. In other embodiments, the shield may have different shapes. For example, the shield may hug both the outer circumference of the shorting ring 422 and an inner circumference of the shorting ring 422, and fit over the surface of the groove 437 on either side of the welding tip 461. The consistent cylindrical shape of the shorting rings 422, 424 and the limited radial translation of the welding head 414 offer an opportunity to enclose the welding head 414 in a very effective shield configuration, thereby significantly reducing the exposure of the weld to atmospheric contamination.

The shielding gas is dispersed in a chamber 453 defined by the shield 473. The shield 473 is shown in cross-sectional view to allow a view of the components housed within the chamber 453, such as the electrode 461. The shield 473 is cylindrical, with an open end that fits to or very close to the outer surface of the shorting ring 422 and to the outer surface of the shorting ring 424 when the rotor 420 with attached shorting rings 422, 424 is inverted. The shield 473 is configured to fit relatively close to the surface of the shorting ring 422, but with enough flexibility so that the fixture 444 is able to rotate rotor 420 with attached shorting rings 422, 424. An optional annular seal 476 may be attached to the shield 473 to contact the outer surface of the shorting ring 422 as the fixture 444 turns, further enhancing the isolation of the chamber 453 from the atmosphere. In one embodiment, the seal 476 may be a high temperature fiberglass rope type seal with a metallic core, a seal with a reinforced composite construction, or another similar seal. Other than slight radial movement described below, the orientation of the welding head 414 relative to the rotor 420 does not change during the course of the weld.

To start the manufacturing cycle, referring to FIG. 5, the rotor 420 with attached shorting rings 422, 424 is secured to the fixture 444 that ensures the precise radial and axial position of the rotor 420 with attached shorting rings 422, 424 and supplies an electrical grounding path for welding. The fixture 444 raises the rotor 420 with attached shorting rings 422, 424 to the position shown. In this position the shorting ring 422 contacts or is immediately adjacent the lower portion of the shield 473 and aligns the groove 437 with the continuous wire electrode 461 that protrudes from the GMAW welding torch 477. After the rotor 420 with attached shorting rings 422, 424 is in the position of FIG. 5, the shield gas is introduced through the supply tube 471 from the reservoir (not shown), to evacuate the ambient atmospheric gas from the chamber 453 and provide the needed inert environment. Finally, the weld is initiated as the rotation of the rotor 420 with attached shorting rings 422, 424 and the feed speed of the continuous wire electrode 461 is synchronized to fill the groove 437 with molten metal 481 that quickly solidifies in the shielded environment. The weld head 414 is controlled to weld the rotor 420 and shorting ring 422, substantially in the predetermined welding position shown, while the fixture 444 simultaneously turns the assembled rotor 420 and shorting rings 422, 424 so that the weld head 414 welds along circular weld path 490 indicated in phantom in FIG. 9.

The weld pattern may require more than one rotation of the rotor 420 with attached shorting rings 422, 424, necessitating a small radial translation of the GMAW welding head 414 and torch 477 to a second predetermined welding position indicated by point 483 in FIG. 5. The fixture 444 would continue rotating the rotor 420 with shorting rings 422, 424 attached thereto to create a second substantially circular weld along a second substantially circular weld path 487 (shown in FIG. 9) radially adjacent to the respective weld path 490 so that there are two side-by-side welds in the groove 437. Additional iterations of slight radial movement of the welding head 414 and rotation of the fixture 444 can be carried out as necessary until the groove 437 is adequately filled with weld material.

At the conclusion of the weld pattern, the rotor 420 with attached shorting rings 422, 424 is removed from the fixture 444, the welding head 414 is returned to the predetermined welding position of FIG. 5. The rotor 420 with attached shorting rings 422, 424 is reoriented so that the shorting ring 424 can be welded to the conductor bars 418 in the groove 439 using the same fixture 444 and welding head 414. The next rotor assembly (rotor with attached shorting rings) is then placed in the fixture 444 for the start of the next cycle. Alternately, the conductor bars 418 and shorting ring 424 could be welded in the groove 439 using a different fixture and welding head. Any excess weld bead protruding from the end faces 431, 433 of the shorting rings 422, 424 could be machined to a desired profile.

A method 500 of welding the induction motor 412 of FIGS. 5 and 9 is shown in the flow diagram of FIG. 6. The method 500 is carried out by the controller 446 pursuant to an algorithm stored in a processor in the controller 446. The method 500 includes block 502, supporting the rotor 420 with attached shorting rings 422, 424 such that the rotor 420 is rotatable about the axis of rotation 428. The rotor 420 is supported in this manner by the fixture 444 clamping or otherwise securing itself to the shorting ring 424 as shown in FIG. 5. The method 500 further includes block 504, attaching a shield 473 to or around the welding head 414, with the shield 473 having a shape at a distal end that is configured to be substantially complementary to the cylindrical outer surface of the shorting rings 422, 424. The shield 473 may be attached during the initial assembly of the welding apparatus 410, prior to the welding of the rotor 420.

In block 506, the welding head 414 is positioned in the predetermined welding position shown in FIG. 5 adjacent the groove 437 of the shorting ring 422 into which the conductor bars 418 extend. In the predetermined welding position, the shield 473 substantially matches the outer surface of the shorting ring 422 so that the shield 473 defines the substantially enclosed chamber 453. There may be a slight gap between the shield 473 and the shorting ring 422 to allow for the shielding gas flow to escape. Block 506 includes block 508, moving the rotor 420 toward the welding head 414 and shield 473 via the fixture 444. Alternately, the welding head 414 and the shield 473 could be moved toward the rotor 420 and fixture 444.

With the welding head 414 in the predetermined welding position and the rotor 420 with attached shorting rings 422, 424 supported by the fixture 444, in block 510, the welding head 414 is then controlled to simultaneously weld the conductor bars 418 to the shorting ring 422 as the fixture 444 turns the rotor 420, creating the circular weld path 490 in groove 437 as indicated in FIG. 9. Depending on the width of the groove 437, more than one substantially circular weld within the groove 437 may be desirable. In some embodiments, the method 500 may include block 512, moving the welding head 414 radially with respect to the rotor 420 within the groove 437. The moving in block 512 is by the robotic arm 460 and is in a radial direction (i.e., perpendicular to axis of rotation 428). In the embodiment shown, welding head 414 moves radially inward, closer to the axis of rotation 428 within the groove 437 to point 483 shown in FIG. 5. In block 514, the welding head 414 is then controlled to weld the conductor bars 418 to the shorting ring 424 while the fixture 444 rotates the rotor 420 with attached shorting rings 422, 424, thus welding along the substantially circular weld path 487 of FIG. 9, creating side-by-side welds in the groove 437.

After the welding in groove 437 is complete, the fixture 444 moves away from the welding head 414 in block 514, in a direction opposite arrow 448, and releases the rotor 420 and shorting rings 422, 424 in block 516. Optionally, the rotor 420 may be repositioned on the fixture 444 in block 518 so that the shorting ring 424 is adjacent the welding head 414. The conductor bars 418 may then be welded to shorting ring 424 on the same fixture 444 by repeating blocks 506 through 516 with the rotor 420 and attached shorting rings 422, 424 repositioned on the fixture 444 in this manner.

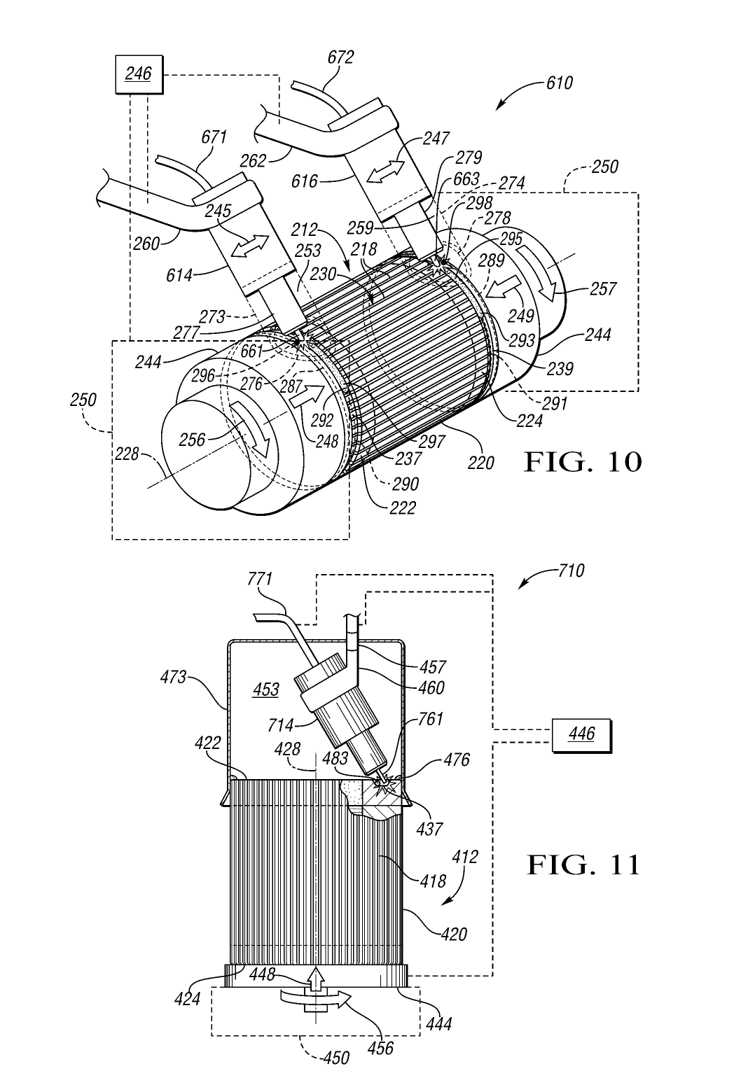

Referring to FIG. 10, a fourth embodiment of a welding apparatus 610 is shown. The welding apparatus 610 has many of the same components as the welding apparatus 210 of FIG. 3, and such identical components are referred to using the same reference numbers. Instead of GMAW welding heads 214, 216, the apparatus 610 uses laser beam or electron beam welding heads 614, 616. The laser or electron beam welding heads 614, 616 with respective welding torches 277, 279 are fixed in a biased radial position relative to the rotor 220 that is appropriate for the delivery of respective laser or electron beams 661, 663 with the ability to translate axially along the width of the respective groove 237, 239 as the weld pattern is implemented. The beams 661, 663 are provided through respective flexible fiber cables 671, 672 having the ability to deliver the required weld power. The shields 273, 274 are useful for preventing the beams 661, 663 from inadvertently being viewed during active welding. Optionally, the shorting rings 222, 224 could be formed without grooves, similar to shorting rings 22, 24 of FIG. 7, as laser or electron beam welding does not deposit weld material. In that case, the material of the shorting rings along the weld paths could be machined to a smooth surface.

The welding apparatus 610 may be operated according to the method 300 of FIG. 4 to simultaneously weld the shorting rings 222, 224 to the conductor bars 218 using laser or electron beam welding along dual circular weld paths 290, 291, and optionally move axially to weld along second dual circular weld paths 287, 289.

Referring to FIG. 11, a fifth embodiment of a welding apparatus 710 is shown. The welding apparatus 710 has many of the same components as the welding apparatus 410 of FIG. 5, and such identical components are referred to using the same reference numbers. Instead of a GMAW welding head 414, the apparatus 710 uses a laser beam or electron beam welding head 714. The laser or electron beam welding head 714 is fixed in a biased radial position relative to the rotor 420 that is appropriate for the delivery of a laser or electron beam 761, with the ability to translate radially along the width of the groove 437 as the weld pattern is implemented. In the case of a laser beam 761, the light beam is provided through a flexible fiber cable 771, having the ability to deliver the required weld power. The shield 473 is useful for preventing the laser or electron beams 761 from inadvertently being viewed during active welding. Optionally, the shorting rings 422, 424 could be formed without grooves, similar to shorting rings 22, 24 of FIG. 7, as laser or electron beam welding does not deposit weld material. In that case, the material of the shorting rings along the weld paths could be machined to a smooth surface.

The welding apparatus 710 may be operated according to the method 500 of FIG. 6 to simultaneously weld the shorting rings 422, 424 to the conductor bars 418 using laser or electron beam welding along dual circular weld paths 490, 491 shown in FIG. 9, and optionally move radially to weld along a second dual circular weld path, such as dual weld path 487.

Accordingly, the various embodiments of welding apparatuses and methods of welding shown and described with respect to FIGS. 1-11 allow for efficient manufacture of induction motors by precise welding of conductor bars to shorting rings with reduced manufacturing cycle times using types of welding (e.g., friction stir welding, or fusion welding, such as GMAW welding, GTAW welding, electron beam welding, laser beam welding, or a combination of fusion welding with laser welding heretofore not used on these types of motors.

While the best modes for carrying out the invention have been described in detail, those familiar with the art to which this invention relates will recognize various alternative designs and embodiments for practicing the invention within the scope of the appended claims.

1. A welding apparatus for an induction motor; wherein the induction motor has an annular rotor defining an axis of rotation, conductor bars spaced about an outer surface of the annular rotor, and first and second shorting rings connected at first and second ends of the annular rotor, the apparatus comprising:
a fixture operable to support the rotor and rotate the rotor about the axis of rotation;
a welding head supported adjacent the fixture and operable to weld the conductor bars to the first shorting ring when the fixture supports the rotor;
at least one controller operable to control the fixture to selectively rotate the rotor; wherein the at least one controller is operable to move at least one of the welding head and the fixture so that the welding head is in a welding position and to cause the welding head to weld the conductor bars to the first shorting ring while remaining in the welding position with the rotor rotating to create a substantially circular weld path along the first shorting ring.

2. The welding apparatus of claim 1, wherein the welding head is a first welding head and the substantially circular weld path is a first substantially circular weld path; and further comprising:
a second welding head supported adjacent the fixture such that the second welding head is axially spaced from the first welding head and is operable to weld the conductor bars to the second shorting ring when the fixture supports the rotor;
wherein the at least one controller is operable to move the second welding head between a respective initial position and a respective welding position and to cause the second welding head to weld the conductor bars to the second shorting ring while remaining in the respective welding position with the rotor rotating to create a second substantially circular weld path along the second shorting ring simultaneously with the first substantially circular weld path.

3. The welding apparatus of claim 1, wherein the first shorting ring is formed with a substantially circular groove on an outer cylindrical surface of the first shorting ring; wherein the conductor bars are exposed in the groove; and wherein the substantially circular weld path is in the groove.

4. The welding apparatus of claim 3, wherein the controller is operable to move the welding head axially with respect to the rotor in the groove from the welding position to an additional welding position to create another substantially circular weld path within the groove when the rotor rotates and the welding head is in the additional welding position, thereby allowing side-by-side welds in the groove.

5. The welding apparatus of claim 4, wherein the welding head moves radially with respect to the rotor from an initial position to the welding position.

6. The welding apparatus of claim 3, wherein the first shorting ring has a substantially circular groove on an outer surface of the first shorting ring; wherein the conductor bars are exposed in the groove; and wherein the weld path is in the groove.

7. The welding apparatus of claim 6, wherein the outer surface of the first shorting ring having the substantially circular groove is substantially perpendicular to the axis of rotation of the rotor; wherein the controller is operable to move the welding head radially with respect to the rotor in the groove from the welding position to an additional welding position to create another substantially circular weld path within the groove when the rotor rotates and the welding head is in the additional welding position, thereby allowing side-by-side welds in the groove.

8. The welding apparatus of claim 1, further comprising: at least one roller positioned to contact one of the fixture and the rotor to provide reaction force to counteract force of the welding head on the rotor.

9. The welding apparatus of claim 1, wherein the welding head is one of a gas metal arc (GMAW) welding head, a gas tungsten arc (GTAW) welding head, a plasma arc welding head, a laser beam welding head, an electron beam welding head, and further comprising:
a shield attached to the welding head and having a shape configured to substantially fit to or near the outer surface of the rotating rotor when the rotor is supported by the fixture and the welding head is in the welding position to thereby define a substantially enclosed chamber around the welding head.

10. The welding apparatus of claim 9, further comprising:
a seal connected to the shield and configured to contact the outer surface of the rotating rotor when the rotor is supported by the fixture and the welding head is in the welding position.

11. The welding apparatus of claim 1, wherein the welding head is one of a friction stir welding head, a gas metal arc (GMAW) welding head, a gas tungsten arc (GTAW) welding head, a plasma arc welding head, a laser beam welding head, and an electron beam welding head.

12. A method of welding an induction motor having an annular rotor defining an axis of rotation, conductor bars spaced about an outer surface of the annular rotor, and a shorting ring connected at an end of the annular rotor with the conductor bars extending into at least a portion of the shorting ring, the method comprising:
supporting the rotor such that the rotor is rotatable about the axis of rotation;
positioning a welding head in a predetermined welding position adjacent the portion of the shorting ring into which the conductor bars extend; and
simultaneously rotating the rotor and welding the conductor bars to the shorting ring with the welding head remaining substantially in the predetermined position so that the welding held welds along a substantially circular weld path.

13. The method of claim 12, wherein the positioning the welding head in the predetermined welding position includes moving the welding head substantially along a center axis of the welding head from an initial position to the predetermined welding position.

14. The method of claim 12, wherein the welding head is a first welding head, the shorting ring is a first shorting ring, and the predetermined welding position is a first predetermined welding position; wherein the induction motor includes a second shorting ring connected at another end of the annular rotor with the conductor bars extending into at least a portion of the second shorting ring, and further comprising:
positioning a second welding head in a second predetermined welding position axially spaced from the first welding head and adjacent the portion of the second shorting ring into which the conductor bars extend; and
welding the conductor bars to the second shorting ring with the second welding head remaining substantially in the second predetermined welding position simultaneously with said rotating the rotor and said welding the conductor bars to the first shorting ring so that the second welding head welds along another substantially circular weld path.

15. The method of claim 12, further comprising:
attaching a shield to the welding head; wherein the shield has a shape configured to substantially fit along the outer surface of the rotating rotor when the rotor is supported by the fixture and the welding head is in the predetermined welding position to thereby define a chamber around the welding head.

16. The method of claim 12, wherein the welding is friction stir welding.

17. The method of claim 12, wherein the welding head is one of a gas metal arc (GMAW) welding head, a gas tungsten arc (GTAW) welding head, a plasma arc welding head.

18. The method of claim 12, wherein the welding head is a laser beam welding head or an electron beam welding head.

19. The method of claim 12, wherein the predetermined welding position is in a groove formed in the shorting ring; and further comprising:
moving the welding head with respect to the groove to another predetermined welding position after said welding; and
welding along another substantially circular welding path so that the welding paths are side-by-side in the groove.

20. A welding apparatus for an induction motor; wherein the induction motor has an annular rotor defining an axis of rotation, conductor bars spaced about an outer surface of the annular rotor, and first and second shorting rings connected at first and second ends of the annular rotor, the apparatus comprising:
a fixture operable to support the rotor and rotate the rotor about the axis of rotation;
a first welding head supported adjacent the fixture and operable to weld the conductor bars to the first shorting ring when the fixture supports the rotor;
a second welding head supported adjacent the fixture such that the second welding head is axially spaced from the first welding head and is operable to weld the conductor bars to the second shorting ring when the fixture supports the rotor; wherein the first and the second welding heads are one of friction stir welding heads, gas metal arc (GMAW) welding heads, gas tungsten arc (GTAW) welding heads, plasma arc welding heads, laser beam welding heads, and electron beam welding heads;
at least one controller operable to control the fixture to selectively rotate the rotor; wherein said at least one controller is operable to move the first and the second welding heads between respective initial positions and respective welding positions and to cause the first and the second welding heads to simultaneously weld the conductor bars to the first shorting ring and to the second shorting ring while remaining in the respective welding positions with the rotor rotating to create dual, substantially circular weld paths along the first and the second shorting rings.
